(19) United States
(12) Patent Application Publication
(10) Pub. No.: US 2003/0167026 A1
(43) Pub. Date: Sep. 4, 2003

(54) Therapeutic massage vibrator

(76) Inventor: Yoichiro Tsujii, Mie (JP)

Correspondence Address: FISH & RICHARDSON P.C., 45 ROCKEFELLER PLAZA, SUITE 2800, NEW YORK, NY, 10111, US

(21) Appl. No.: 10/231,230

(22) Filed: Aug. 29, 2002

(30) Foreign Application Priority Data
Mar. 1, 2002 (JP) 2002-56302

(51) Int. Cl. A61H 23/02

(52) U.S. Cl. 601/46; 601/72; 601/80

(57) ABSTRACT

A therapeutic massage assisting apparatus for treating a muscle hardening in an easy and painless manner is provided. The therapeutic massage assisting apparatus (1) comprises a massage fitting (2) and a vibrator (3). The massage fitting 2 comprises a columnar member (2b) whose tip potion (2c) is to come into contact with the skin of a patient.

### BACKGROUND OF THE INVENTION

1. Field of the Invention

The present invention relates to a therapeutic massage assisting apparatus and particularly to the apparatus for relaxing muscle hardening (taut band).

2. Description of the Related Art

Categories of muscle pathology include a pathophysiological reaction due to an injury in a muscle itself, and a physiological reaction caused by a defensive reaction of the muscle which is secondarily caused by a pain or the like accompanying an injury. The category of the pathophysiological reaction includes myomalacia and muscle hardening, for example, while that of the physiological reaction includes myospasm and myoedema, for example.

It is important for the treatment of muscle diseases (myotherapy) to eliminate a muscle hardening, which is responsible for pain in muscle pain syndrome, local myofascial pain syndrome, and systemic fibromyalgia syndrome. Muscle hardening takes place when only a part of the fibers of a muscle abnormally contracts in a state of a so-called hypertonicity.

In the treatment of muscle diseases according to the prior techniques, attempts are made to gradually reduce physiological reactions such as myospasm, myoedema by applying a pressure-friction stimulation either manually or by using a massage tool, so that the muscle hardening which was localized in the process can be healed by taking advantage of an inflammatory reaction (repair reaction). When it is impossible to deliver sufficient stimulation to a particular location by the hand only, acupuncture, for example, has been employed to provide a certain level of stimulation.

However, acupuncture is accompanied by pain and is incapable of easily delivering a stimulation directly to the muscle hardening. This is because a muscle hardening has a diameter in the range of from about 0.05 to 2 mm and a length exceeding about 1 cm, and it is so hard that the needle is bent by the hardened of the muscle.

In view of these problems of the prior techniques, it is an object of the present invention to provide a metal therapeutic massage assisting apparatus which can easily cause a repair reaction to take place in a muscle hardening.

### SUMMARY OF THE INVENTION

The present invention provides a therapeutic massage assisting apparatus for relaxing a muscle hardening, comprising a metal massage fitting and a vibrator. The massage fitting comprises a columnar member having a tip portion which is arched in at least axial cross-section. The vibrator provides a low-frequency vibration substantially in an axial direction of the columnar member.

A rear-end portion of the columnar member of the metal massage fitting may be attached to the vibrator.

The metal massage fitting may further comprise a thick disc-shaped member at the rear-end portion of the columnar member, the disc-shaped member having a larger diameter than that of the columnar member. The vibrator may be attached to the thick disc-shaped member.

The frequency of the vibration in the metal columnar member may be in the range of from 10 to 70 Hz.

It is believed that by gently pressing the tip portion of the columnar member of the metal massage fitting onto the muscle hardening of interest such that no pain is caused, and delivering a low-frequency vibration thereto, an inhibitory effect of muscle tone is produced which facilitates the relaxation of the muscle hardening. As a result, while it typically took several months or years before a certain type of muscle hardening began to show relaxation, the therapeutic massage assisting apparatus according to the invention enables relaxation of a muscle hardening, which is the goal of the treatment of the muscle pain syndrome, to occur within five seconds, which is a drastic reduction in time. This is believed due to an inhibitory reflex effect of muscle tone at spinal or higher centers in the central nervous system, or an improvement in local circulatory dynamics caused by an increase in the flow of water due to molecular diffusion.

Because the axial cross-section of the tip portion of the columnar member of the metal massage fitting is arched, the fitting can be pressed onto the skin without causing pain. If there is even a slight pain during therapy, the pain reflex brings about an increase in muscle tone, making it difficult to control the muscle tone which is the object of the therapy. By making the shape of the tip portion of the columnar member arched and providing a low-frequency vibration, it becomes possible to achieve the object of the treatment, i.e., to control the muscle tone in a painless manner. As a result, the patient is not subjected to worries or pains, and that further facilitates muscle relaxation.

Treatment is particularly made easier by attaching the vibrator to the rear-end portion of the columnar member of the massage fitting and replacing the tip portion of the columnar member according to the type of stimulation or area (region) suitable for the particular pathological condition.

Further, by using the therapeutic massage assisting apparatus according to the present invention, physical burden on the therapist can be decreased, allowing her/him to see more patients per day.

By employing the thick disc-shaped member at the rear-end portion of the columnar member, with the disc-shaped member having a larger diameter than that of the columnar member, it becomes easier to take hold of the massage fitting and the therapy becomes easier.

By using the frequency in the range of from 10 to 70 Hz delivered substantially along the axis of a cylindrical columnar member, the muscle hardening can be relaxed by reflex (presynaptic inhibition).

### BRIEF DESCRIPTION OF THE DRAWINGS

FIG. 1 is a cross-sectional view of the main portion of a therapeutic massage assisting apparatus according to a first embodiment of the present invention;

FIG. 2 is a perspective view of a metal massage fitting of the therapeutic massage assisting apparatus of FIG. 1;

FIG. 3 is a cross-sectional view of the main portion of a therapeutic massage assisting apparatus according to a second embodiment of the present invention;

FIG. 4 is a perspective view of a metal massage fitting of the therapeutic massage assisting apparatus of FIG. 3; and

FIG. 5 is a perspective view of a metal massage fitting of a therapeutic massage assisting apparatus according to another embodiment of the present invention.

### DESCRIPTION OF THE PREFERRED EMBODIMENTS

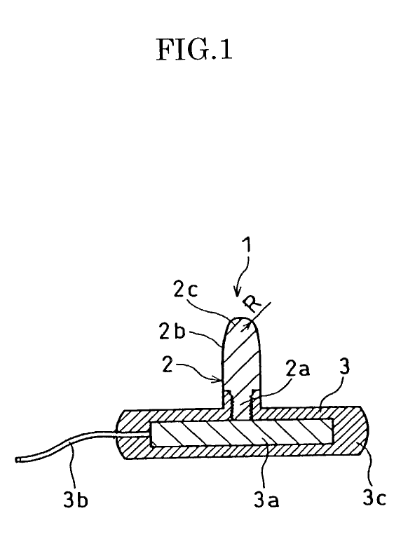

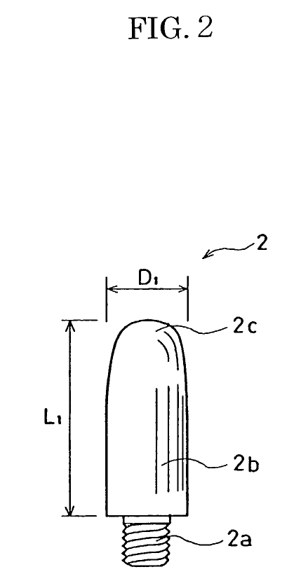

Hereafter a first embodiment of the therapeutic massage assisting apparatus according to the present invention will be described. FIG. 1 shows a cross-sectional view of the main portion of the therapeutic massage assisting apparatus according to the present embodiment. FIG. 2 shows a perspective view of a metal massage fitting of the therapeutic massage assisting apparatus of FIG. 1.

The therapeutic massage assisting apparatus 1 of FIG. 1 comprises a metal massage fitting 2 and a vibrator 3. The metal massage fitting 2 is attached to a grip portion 3c of the vibrator 3. The vibrator 3 is designed to provide a low-frequency vibration in an axial direction of the metal massage fitting 2. Preferably, a switch (not shown) is attached to the vibrator 3.

As shown in FIG. 2, the metal massage fitting 2 comprises a columnar member, such as a cylindrical member 2b, and a mount portion 2a provided at a rear-end portion of the cylindrical member 2a. The cylindrical member 2b has a tip portion 2c which is arched in at least axial cross-section. It is only necessary that the tip portion 2c of the columnar member is arched in axial cross-section. A preferred embodiment of the columnar member is the cylindrical member 2b. In operation, the arched tip portion 2c is contacted to the skin and a low-frequency vibration is provided by the vibrator 3 in the axial direction of the cylindrical member 2b.

The metal massage fitting 2 comprises a mount portion 2a with such a structure as to enable the metal massage fitting to be detachably attached to the vibrator 3. Thus, a length L1, diameter D1 and radius of curvature R of the metal massage fitting 2 can be changed depending on particular therapy needs. The mount portion 2a may be of any type as long as it can ensure the metal fitting does not fall away from the vibrator 3 during therapy. For example, it can be of screw type, insertion type, or bolted type.

Examples of the dimensions of the metal massage fitting 2 include the length L1 ranging from 3 to 10 cm, the diameter D1 ranging from 0.5 to 3 cm, and the radius of curvature R ranging from 0.5 to 2 cm.

The metal massage fitting 2 is preferably made of a metal material such as, e.g., brass. Brass provides a closer fit to the skin and surface smoothness. Since the metal massage fitting 2 comes into contact with the skin and the fitting may be heated up to the body temperature, the high thermal conductivity of brass is most suitable. Compared with a cylinder made of wood, metal materials are superior because they do not impart pain or stimulation to the skin by the friction caused by massaging, and thus they can better inhibit the muscle tone caused by pain stimulation.

The tip portion 2c of the metal massage fitting 2 may be plated or provided with a fluoroplastic coating for rust proofing purposes.

The tip portion 2c of the metal massage fitting 2 has an arched axial cross-section. Fittings with a different radius of curvature of the arch may be selected depending on the physiological and/or pathological conditions including whether the particular muscle group is of the surface or deep layer type. For example, in a severe case of myospasm or myoedema, if the person being massaged complains of a severe pain, the radius of curvature of the tip portion 2c should be increased. As the myospasm or myoedema decreases in severity and a circumscribed muscle hardening is palpated, the muscle hardening must be relaxed and for this reason a metal massage fitting with a smaller radius of curvature should be used to provide local stimulation. Thus, the radius of curvature of the metal massage fitting 2 may be chosen depending on particular physiological or pathological conditions.

The vibrator 3 may be of any type as long as it is capable of providing a low-frequency vibration in an axial direction of the cylindrical member 2b of the metal massage fitting 2.

The low-frequency vibration is provided to the metal massage fitting 2 by, e.g., a vibrator mechanism 3a built inside the vibrator 3, as shown in FIG. 1. The vibrator mechanism 3a may be based on transformation of rotary motion into vertical motion, or electromagnetic vertical motion, for example.

The low-frequency vibration is imparted along the axis of the metal massage fitting 2. Its frequency is preferably in the range of from 10 to 70 Hz, most preferably about 30 Hz. When the frequency is smaller than 10 Hz, no muscle relaxing effect can be obtained, and in excess of 70 Hz, facilitation (which helps cause muscular contraction) results. The amplitude of the low-frequency vibration may be varied depending on the particular muscle hardening. The amplitude should preferably be 3 mm or more. It is sufficient to provide the low-frequency vibration for 2 to 10 seconds or preferably 3 to 5 seconds. Between 2 to 10 seconds, a swift muscle relaxation can be obtained.

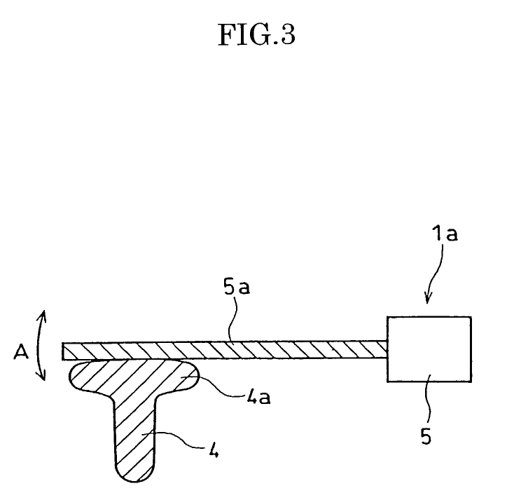

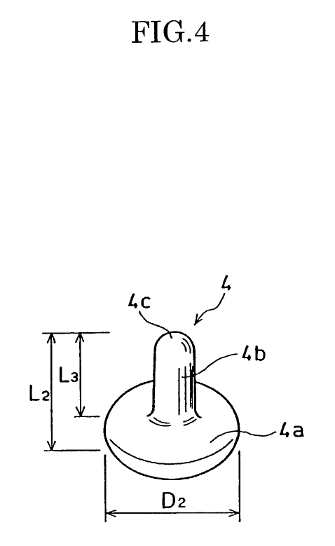

Hereafter, a second embodiment of the therapeutic massage assisting apparatus according to the present invention will be described by referring to FIGS. 3 and 4. FIG. 3 shows a cross-section of the main portion of the therapeutic massage assisting apparatus according to the second embodiment. FIG. 4 shows a perspective view of a metal massage fitting of the therapeutic massage assisting apparatus according to the second embodiment.

A therapeutic massage assisting apparatus 1a of the second embodiment comprises a metal massage fitting 4 and a vibrator 5 which is attached to the metal massage fitting for providing a low-frequency vibration substantially in an axial direction of the metal massage fitting 4.

As shown in FIG. 4, the metal massage fitting 4 comprises a columnar member with, such as a cylindrical member 4b a tip portion 4c, and a thick disc-shaped member 4a with a large diameter. The tip portion 4c has an arched cross-section at least in the axial direction. The disc-shaped member 4a is integrally formed with the cylindrical member 4b. The columnar member needs only to have an arched axial cross-section in the tip portion 4c. A preferred embodiment of the columnar member is the cylindrical member 4b, which is integrally and concentrically formed with the thick disc-shaped member 4a. In operation, the arched tip portion 4c is brought in contact with the skin and vibrated at low frequency by the vibrator 5 in substantially the axial direction of the cylindrical member 4b. Alternatively, the metal massage fitting 4 may be vibrated manually by holding the rear-end portion or the disc-shaped member 4a as a grip.

The metal massage fitting 4 may be dimensioned such that, for example, a length L2 from the tip portion 4c to the rear-end portion 4a is from 6 to 10 cm, a diameter D2 of the rear-end portion 4a is from 6 to 8 cm, and a length L3 of the cylindrical member 4b is from 3.5 to 6.5 cm. By dimensioning this way, the weight of the metal massage fitting 4 used can be controlled to be in a range of from 480 to 1280 g. By thus controlling the weight to be from 480 to 1280 g, appropriate stimulation can be selectively provided to the muscle to be massaged, in accordance with the location or condition of the muscle.

For example, the metal massage fitting 4 with a heavy weight ranging from 1120 to 1280 g, for example, should be appropriate for the therapy of a deep-layered muscle group (such as the buttocks or low back), where the user must apply her/his weight on the apparatus to reach the intended location. On the other hand, lighter weights should be more appropriate for therapy on a relatively surface layered muscle group (such as the neck region or upper limb), where more detailed sites should be explored.

Further, a longer length L3 of the cylindrical member 4b is more suitable for examining a deeper-layered muscle group, while a shorter length L3 is more appropriate for a more surface-layered muscle group, for it allows for a more stable exploration of the muscle group. When examining a deep-layered muscle group, an intermediate length of L3 may be employed in the case of a high muscle tone and too deep a region must not be reached.

The material of the metal massage fitting 4 and the shape of the tip portion 4c may be identical to those of the metal massage fitting 2 and tip portion 2c described earlier.

The vibrator 5 may be of any type as long as it is capable of providing a low-frequency vibration substantially in an axial direction of the cylindrical member 4b of the metal massage fitting 4.

The low-frequency vibration in the present apparatus can be delivered by vibrating a support member 5a about a support axle in the vibrator 5 in a vertical direction A, as shown in FIG. 3. Alternatively, the vibrator 5 itself may vibrate vertically. The vibration mechanism may be based on conversion of rotary motion into vertical motion, electromagnetic vertical motion, etc.

The rear-end portion 4a of the metal massage fitting 4 is fixedly secured to the support member 5a. The manner of securing may be either mechanically by screws or chemically by glue as long as it can prevent separation during vertical vibrations.

Alternatively, the support member 5a and the rear-end portion 4a of the metal massage fitting 4 may be held simultaneously by hand so that the vertical vibration of the support member 5a can be applied to the affected area.

While two preferred embodiments have been described for purposes of disclosure, it is to be understood that the invention is not limited to those embodiments, but on the contrary, is intended to cover various modifications and equivalent arrangements included within the spirit and scope of the appended claims.

For example, in the first embodiment, the low-frequency vibration may be provided substantially along the axis of the metal massage fitting 2, and the vibration's frequency range, amplitude, duration, etc., may be identical to those of the therapeutic massage assisting apparatus 1a according to the second embodiment.

Furthermore, while brass was used as the material for the massage fitting 2 in the above two embodiments, this is only exemplary and other metal materials may be employed for producing the massage fitting 2 and 4 in the present invention.

The material for the massage fitting 2 and 4 is not limited to metal materials and may include ceramics or plastics.

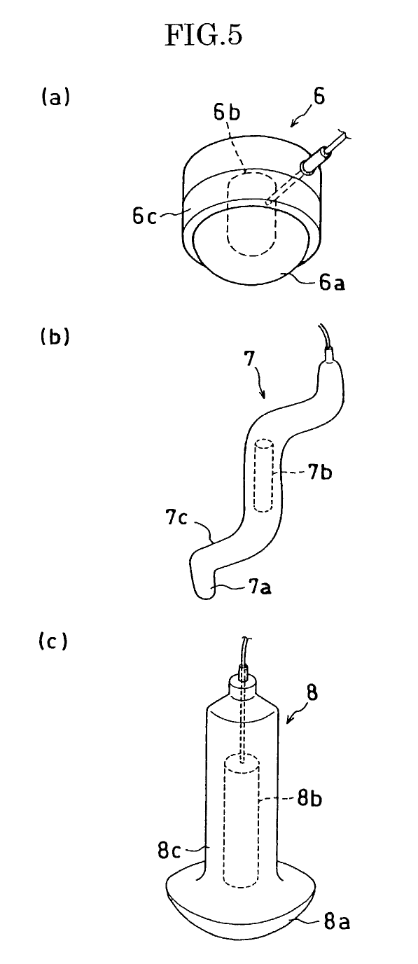

The therapeutic massage assisting apparatus according to the present invention is not limited to the above two embodiments and may be embodied in various other ways, as shown for example in FIG. 5.

In FIG. 5(a) to (c), the therapeutic massage assisting apparatus 6, 7 and 8 each comprise a massage fitting 6c, 7c and 8c, respectively, and a vibrator 6b, 7b and 8b built inside the massage fitting 6c, 7c and 8c, respectively. Each massage fitting 6c, 7c or 8c is column-shaped and provided with an arched tip portion 6a, 7a or 8a, respectively. The arched tip portion 6a, 7a or 8a is designed to come into contact with the skin to apply pressure thereon and has a radius of curvature of 9 mm.

Thus, the therapeutic massage assisting apparatus according to the present invention is suitable for relaxing muscle hardenings which are responsible for the pain in muscle pain syndromes, local myofascial pain syndrome, systemic fibromyalgia syndrome and the like. It is believed that the therapeutic massage assisting apparatus according to the present invention prompts a muscle inhibitory effect which facilitates the relaxation of the muscle hardening.

Hereafter, the results of several experiments in which the therapeutic massage assisting apparatus according to the present invention was actually applied to subjects will be described.

The actual experiments were conducted to examine the effect of varying the frequency and tip diameter of the therapeutic massage assisting apparatus on the relaxation of a muscle (elongation in muscle length) of the subject, and the comfort sensation felt by the subject when the frequency was varied.

The experiments involved eight normal healthy subjects (5 men and 3 women, ranging in age from 24 to 43, average age 31.75), using the quadriceps muscle (vastus medialis muscle) of either thigh of each subject.

During the experiments, the subject sat in a long sitting position (where the subject sits on a leg-less chair with legs extended) in a relaxed manner. The vibrator was hung from a frame secured to the floor and was adapted to be adjustable to the thickness of the subject's thigh.

The power was turned on after the tip of the massage fitting was placed on the skin and secured (sunk) so as not to fall off, and then vibratory stimulation was applied for more than five minutes.

The degree of relaxation of the muscle was determined by measuring the degree of intrusion (mm) of the massage fitting into the muscle in the femoral region by using a ruler secured on the frame.

The concrete results of the experiments are as follows.

1. Experiment of Varying the Diameter and Radius of Curvature of the Tip of the Massage Fitting Used

In this experiment, five massage fittings with different shapes (A-E) were used, each made from brass and having a length of 50 mm. The five massage fittings, however, differed in the diameter and radius of curvature of the tip which contacts (by bonding) the subject.

Specifically, the massage fittings were dimensioned such that: A=diameter 8 mm, radius of curvature 4 mm; B=diameter 15 mm, radius of curvature 7.5 mm; C=diameter 18 mm, radius of curvature 9 mm; D=diameter 24 mm, radius of curvature 12 mm; and E=diameter 30 mm, radius of curvature 15 mm.

The frequency was 30 Hz and the amplitude was 5 mm in the experiments.

The degree of relaxation of the muscle was expressed by an average value of measurement values of the eight subjects, and a standard deviation value with reference to the average value, the latter indicating a maximum and minimum of deviation of each measurement value from the average value. Namely, the relaxation degree was expressed by average±standard deviation (mm).

The following are the results of the experiment with the differently shaped massage fittings A-E on the subjects (R=radius of curvature; D1=diameter).

| | |
|---|---|
| A: D1 = 8 mm, R = 4 mm, | average ± standard deviation = 5.75 ± |
| | 0.88 mm |
| B: D1 = 15 mm, R = 7.5 mm, | average ± standard deviation = 5.83 ± |
| | 0.98 mm |
| C: D1 = 18 mm, R = 9 mm, | average ± standard deviation = 8.50 ± |
| | 4.85 mm |
| D: D1 = 24 mm, R = 12 mm, | average ± standard deviation = 4.83 ± |
| | 2.07 mm |
| E: D1 = 30 mm, R = 15 mm, | average ± standard deviation = |
| | 5.08 ± 3.02 mm |

These results indicate that the massage fitting C has the largest average value of muscle relaxation degree and thus the greatest muscle relaxation effect. Further, since the standard deviation indicates the variation of muscle hardness of each subject, the massage fitting C, with the greatest standard deviation value, has high diagnostic significance in muscle pathology. This also means that a high level of expertise is required of the therapist using this massage fitting.

The results of the experiment indicate the effect on the surface layer muscle. Against the deep layer muscle, the skin, subcutaneous tissue and muscle show greater resistance with an increasing diameter and radius of curvature of the tip of the massage fitting. This shows that with respect to the deep layer muscle, less force is required from the therapist to push the massage fitting into the patient's body when using a massage fitting with a tip of smaller diameter and radius of curvature.

As the diameter and radius of curvature of the tip decreases, however, the external force applied to the skin of the patient increases, resulting in a possibility of skin damage. When the massage fitting A with the tip diameter of 8 mm was used, most of the subjects complained of pain. Further, even when the massage fitting B with the tip diameter of 15 mm was used, a few complained of pain.

2. Experiment of Varying the Frequency Applied to the Massage Fitting

In this experiment, the frequency was 30 Hz or 70 Hz, and the amplitude was 5 mm.

The results of the experiment showed that the muscle relaxation degree was 8.38±3.99 mm and 4.19±1.99 mm (average±standard deviation) in the case of 30 Hz and 70 Hz, respectively

There was a statistically significant difference in this experiment (p<0.009). Namely, it will be understood that the massage fitting using 30 Hz has a significantly greater effect of relaxing the muscle than the one using 70 Hz.

3. Experiment Concerning the Frequency at Which the Subject Feels Most Comfortable

In this experiment, the frequency of the massage fitting was in the range of from 10 to 70 Hz and the amplitude was 5 mm.

The frequency was changed from 10 to 70 Hz and vice versa as the massage fitting was being applied under pressure to the subject.

As the frequency was thus varied, each subject was asked to tell the frequency at which he felt most comfortable, and the indicated frequency value was measured.

As a result, the most comfortable frequency (average±standard deviation) was 28.02±4.13 Hz. All of the subjects started feeling unpleasantness at frequencies around 55 Hz. One of the subjects endured up to 80 Hz, and another endured up to 100 Hz. The others stopped the experiment at lower frequencies.

Hereafter, it will be described specifically how the therapeutic massage assisting apparatus according to the present invention was used on a patient with a limited range of motion (contracture) in a joint for experimental therapy, and how the range of motion in the joint was measured before and after the experimental therapy, to show the effect of the therapeutic massage assisting apparatus.

A limitation in the range of motion in the joints, particularly a contracture of the joint, greatly affects the daily life of people, lowering their quality of life (QOL). For example, a contracture of the knee joint makes it difficult for the patient to lead a traditional Japanese style of living with squatting toilets and tatami straw mats, while a contracture in the shoulder joint creates problems when taking things in and out of the cupboard.

At senior citizens' or nursing homes, not only the residents with contractures in the hip or knee joint but also those taking care of them are forced to have difficulties in doing chores on the bed, such as, e.g., changing diapers. In an aging society, restrictions in the range of motion in joints present those who take care of the elderly with a number of daily problems, as well as putting a drag on the patient's everyday life.

Therefore, it has long been a serious concern for those engaged in the medical practice, particularly in rehabilitation medicine, how to increase the joint mobility and mobilize people with restored mobility, so that they can return to their normal lives.

The experimental therapy is intended to provide treatment to a patient with a limited range of motion in a joint whose conditions could not be improved by the conventional therapy (as to the details of the conventional therapy, see the following Note 1).

The subject of the experimental therapy included disorders in the central nervous system, such as cerebral hemorrhage, and disorders in the musculoskeletal system without a disorder in the central nervous system.

The experimental subjects included 13 patients with central nervous disorders such as cerebral hemorrhage, and 29 patients with musculoskeletal disorders but without a central nervous system disorder, totaling 42 patients, ranging in age from 26 to 89 with an average age of 62.7.

All of the patients had a limited range of motion in joints and showed no improvement by therapies designed to improve the range of motion in joints, including a joint range of motion exercise and stretching therapy.

In this experimental therapy, the measurement of the range of motion of the joint and the therapy using the therapeutic massage assisting apparatus according to the present invention were conducted by different person, the former by an examiner and the latter by a therapist. While the measurement of the range of motion in the joint and the experimental therapy for the limited range of motion were conducted in the same room, the examiner and the therapist were not allowed to see each other's conduct, i.e., the examination or therapy.

In the present experimental therapy, the range of motion in the joint of each patient was measured prior to therapy. Immediately after that, therapy was conducted, followed immediately by the measurement of the range of motion in the treated joint.

Three kinds (sessions) of the experimental therapy were conducted on each patient. Thus, the measurement of the range of motion in the joint was conducted four times.

(1) As a conventional therapy, a joint range of motion exercise and a stretching therapy were conducted for 20 to 30 minutes. This was followed by (on the same day):

(2) a therapy by the therapeutic massage assisting apparatus according to the invention on muscles (neck or back muscle attached to the spine or ribs) innervated by dorsal primary rami of the same segment of the spinal nerve with the limited range of motion in the joint, for 20 to 30 minutes (the details of this experiment are described later in Note 2)). This was followed by:

(3) a therapy by the therapeutic massage assisting apparatus according to the invention on muscles innervated by ventral primary rami of the spinal nerve where a limited range of motion is suspected, such as, e.g., the knee extensor in the case of a patient with flexion contracture in the knee (where the knee cannot be sufficiently bent), for 20 to 30 minutes.

The results of the above experimental therapy using the therapeutic massage assisting apparatus according to the present invention were as follows.

(1) There were no patients whose range of motion in the joint was improved by the conventional joint range of motion exercise and stretching therapy.

(2) Of the 42 patients who received therapy using the therapeutic massage assisting apparatus according to the invention, an improvement in the range of motion in the joint was seen in 41 patients. The one patient who showed no improvement in the range of motion in the joint had joint ankylosis.

(3) The results of providing therapy to the muscle innervated by the dorsal primary rami of the spinal nerve were as follows.

(a) Of the 29 patients with a musculoskeletal disorder, 28 improved (96.5%). The rate of improvement in the range of motion in the joint was 48%.

(b) Of the 13 patients with a central nervous disorder, eight improved (61.5%). The rate of improvement in the range of motion in the joint was 26%.

(c) The average of the rates of improvement in the range of motion in the joint in both groups was 41%.

(d) In all of the cases, when there was a limited range of motion in a joint in the limb, a shortening was recognized in a muscle innervated by the dorsal primary rami of the spinal nerve of the corresponding spinal level. For example, when there was a limited range of flexion motion in the right knee, a shortening was recognized by palpation in muscle at the right side of the second and third lumbar spinal levels.

(4) The results of therapy of a muscle innervated by the ventral primary rami after the therapy of the dorsal primary rami of the spinal nerve were as follows.

(a) Of the 29 patients with a musculoskeletal disorder, 28 improved (96.5%). The rate of improvement in the range of motion in the joint was 71%.

(b) All of the eight patients with a central nervous disorder improved (100%). The rate of improvement in the range of motion in the joint was 44%.

(c) The average of the rates of improvement in the range of motion in the joint in both groups was 63%.

(d) In all of the cases, a muscle shortening was recognized by palpation in the vicinity of the joint with limited range of motion.

(5) The patients who showed no change after the therapy of the muscle innervated by the ventral primary rami following the therapy of the muscle innervated by the dorsal primary rami of the spinal nerve included:

(a) one of the patients with a musculoskeletal disorder (3.8%); and

(b) none of the patients with a central nervous system illness.

(6) The patients who showed no change following the therapy of the muscle innervated by the dorsal primary rami of the spinal nerve but did show a change after the therapy of the muscle innervated by the ventral primary rami included:

(a) one of the patients with a musculoskeletal disorder (3.8%); and

(b) five of the patients with a central nervous disorder (38.0%).

(7) The patients were classified based on the period of contracture to compare the results of therapy, as shown in Table 1: “Therapy Results Classified by the Contracture Period.”

The results are classified by the patients' periods of contracture of up to one year, one to five years and more than five years, and they indicate the rate of improvement of the patients in each period. The average of the patients' periods of contracture, which ranged from 2 months to 20 years, was four years and three months.

TABLE 1
Therapy Results Classified by the Contracture Period

| | | Rate of improvement (%) | |
|---|---|---|---|
| | | Therapy of a | Therapy of a |
| | | muscle innervated | muscle innervated |
| Period of | Type of | by the dorsal | by the ventral |
| contracture | disorder | primary rami | primary rami |
| Less than 1 | Musculoskeletal | 31.4 | 63.2 |
| year | disorder | | |
| | Central nervous | 30.6 | 48.6 |
| | disorder | | |
| | Average | 31.3 | 60.9 |
| 1 to less | Musculoskeletal | 51.7 | 74.1 |
| than 5 years | disorder | | |
| | Central nervous | 18.2 | 38.7 |
| | disorder | | |
| | Average | 34.2 | 55.6 |
| More than 5 | Musculoskeletal | 51.8 | 77.3 |
| years | disorder | | |
| | Central nervous | 16.4 | 30.1 |
| | disorder | | |
| | Average | 38.7 | 56.2 |

(8) There were eight cases of “no change” in the daily activities of the patients who received the experimental therapy twice by using the therapeutic massage assisting apparatus according to the present invention. However, there were many examples of improvement that were indeed observed, which included: ability to walk without the use of walker; ability to stand with the help of a handrail; disappearance of unequal lengths of legs; restored ability, after five years, to squat and trot; ability to stand with semi-assistance instead of full-assistance; appearance of rotating motion of the trunk; ability to keep standing; ability to keep standing without an orthosis; ability to stand with one leg with the help of a handrail; ease with which to wash or dress hair; ability to use both hands in washing face; ability to put on socks with ease; disappearance of pain when walking; improved ability to walk with only a slight pain; ability to stand up smoothly; disappearance of pain in both wrists, which allowed the patient to use his hands forcefully; ability, after three years, to sit on the floor in Japanese fashion (with one's knees bent and with one's toes directly beneath one's buttocks); appearance of motility in a paralyzed leg; ability to keep standing on both legs; disappearance of pain; reduction of pain in the knee; increased walking step; reduction of pain in walking; ability to sit in Japanese fashion; ability to dress hair; ability to drive a car more easily; liberation from having to wake up at night due to pain; reduction in pain; ability to hang the washing out to dry; increased speed of walking; ability to sleep well at night; almost total disappearance of pain in every movement; ability to walk barefooted; ability to sit in Japanese fashion; and ability to sit in Japanese fashion for a little while.

(Note 1. Conventional Therapy: In rehabilitation therapy, particularly in physical therapy, treatment of the limited range of motion in the joints has long been practiced. The conventional therapy here refers to range of motion exercises in the joints, including a method whereby the patient moves the joint by herself/himself, and a method whereby the entire range of motion of the patient's joint is moved by a therapist.

Often simultaneously used with these joint range of motion exercises is a stretch therapy in which the patient's muscle or the like is stretched. In this method, not only the joint is moved in its entire range of motion, but an attempt is made to stretch a muscle or the like that is believed responsible for the limited range of motion.)

(Note 2. Treatment of a Muscle Innervated by the Dorsal Primary Ramus of Spinal Nerve, Using the Therapeutic Massage Assisting Apparatus of the Invention: The spinal nerves include branches extending from the spinal cord in the spine via intervertebral foramina between the individual vertebrae towards the outside of the spine. When the spinal nerve is compressed or injured in the intervertebral foramina, this injury is called radiculopathy.

Radiculopathy is cited as one of the causes of muscle shortening and joint contracture. A therapeutical method is known (in the literature) for removing pressure on the nerve or the like by relaxing the tensed muscle in the vicinity of the spine such that the narrowed intervertebral foramen through which the spinal nerve passes can be widened. This method has reportedly been able to relax the pressure on the nerves and reduce the tension in the muscle, so that the length of the muscle could be elongated, symptoms of autonomic nervous disorders could be alleviated, and pain or sensory disorders could be improved.

After passing through the intervertebral foramen, the spinal nerve divides into two branches, one (posterior ramus) reaching out to the neck, back, and rear waist, and the other (ventral ramus) extending to the front of the trunk, and upper and lower limbs. The limitation in the range of motion in joints can occur in the spine; however, what is of most concern to every day clinical situations and our daily lives is the limited range of joint motion in the limbs.

The limited range of joint motion in the limbs can occur in the shoulders, elbows, wrists, hands or hip joints, knees, ankles, and feet joints. The muscles controlling the motion of these joints are under the control of the ventral primary rami of the spinal nerve. The muscle attached to the spine is controlled by the dorsal primary rami of the spinal nerve. By relaxing the muscle innervated by the dorsal primary rami, it becomes possible to remove pressure applied to the nerve and secondarily relax the muscle innervated by the ventral primary rami. Accordingly, in the present study, initially the muscle innervated by the dorsal primary rami of the spinal nerve was treated by the therapeutic massage assisting apparatus according to the present invention and the results of the treatment were examined, and then the muscle of a limb controlled by the ventral primary ramus of the spinal nerve was treated to see how this treatment influenced the range of joint motion in the muscle innervated by the ventral primary rami.)

Thus, the therapeutic massage assisting apparatus according to the present invention can improve the above-mentioned mobility of the joint and enhance the activities of the daily living of the patient, thereby increasing the quality of her/his life and helping his re-integration into the community.

By using the therapeutic massage assisting apparatus according to the present invention in treating the patients whose limited range of joint motion could not be improved by the conventional therapy (see Note 1), the conditions of the patients can be improved far beyond what the conventional therapies for contracture suggest possible.

The therapeutic massage assisting apparatus according to the present invention, which comprises a massage fitting having a columnar member with a tip portion which is arched in cross-section at least axially, and a vibrator for providing a low-frequency vibration substantially along the axis of the columnar member, can provide treatment in a painless fashion, unlike other therapies such as acupuncture. Further, by varying the radius of curvature of the tip portion of the massage fitting which is arched in cross section axially, the vibration can be effectively transmitted to the muscle hardening.

Furthermore, since the rear-end portion of the columnar member of the massage fitting is detachably mounted to the vibrator, the massage fitting can be easily replaced with another one with a tip portion with a different radius of curvature. Thus, the vibration can be effectively transmitted in accordance with the type, depth or other features of the muscle hardening.

In another embodiment of the therapeutic massage assisting apparatus according to the present invention, since the massage fitting comprises, at the rear-end portion of its columnar member, a thick disc-shaped member having a larger diameter than that of the columnar member, and the disc-shaped member is detachably mounted on the vibrator, the massage fitting can be changed to another one with a different radius of curvature of the tip portion. Thus, the vibration can be easily transmitted in accordance with the type, depth or other features of the muscle hardening.

Moreover, since the vibrator for providing the low-frequency vibration has a frequency range of 10 to 70 Hz, the vibration can be more effectively transmitted in accordance with the type, depth or the like of the muscle hardening.

What is claimed is:

1. A therapeutic massage assisting apparatus comprising a massage fitting and a vibrator, the massage fitting comprising a columnar member whose tip portion is to come into contact with the skin.

2. The therapeutic massage assisting apparatus according to claim 1, wherein the massage fitting further comprises a thick disc-shaped member at a rear-end portion of the columnar member, the disc-shaped member having a larger diameter than that of the columnar member and being formed either integrally with the columnar member or as a separate member.

3. The therapeutic massage assisting apparatus according to claim 1 or 2, wherein the columnar member is a cylinder.

4. The therapeutic massage assisting apparatus according to any one of claims 1 to 3, wherein the tip portion of the columnar member is arched in cross-section in an axial direction of the columnar member.

5. The therapeutic massage assisting apparatus according to claim 1, wherein the material of the massage fitting is selected from the group consisting of a metal material, a ceramic material, and a synthetic resin.

6. The therapeutic massage assisting apparatus according to claim 1, wherein the material of the massage fitting is brass.

7. The therapeutic massage assisting apparatus according to claim 2, wherein the thick disc-shaped member of the massage fitting has built inside it a vibrating mechanism of the vibrator.

8. The therapeutic massage assisting apparatus according to claim 2, wherein the vibrator is attached to the thick disc-shaped member of the massage fitting.

9. The therapeutic massage assisting apparatus according to any one of claims 1, 7 and 8, wherein the vibrator provides a low-frequency vibration.

10. The therapeutic massage assisting apparatus according to claim 9, wherein the frequency of the low-frequency vibration is in the range of from 10 to 70 Hz.

11. The therapeutic massage assisting apparatus according to claim 1, wherein the therapeutic massage assisting apparatus is used for relaxing a muscle hardening.

12. The therapeutic massage assisting apparatus according to claim 1 or 11, wherein the columnar member is made of brass, 30 to 100 mm in length and about 18 mm in diameter, the arched portion of the tip portion has a radius of curvature of about 9 mm, and the vibrator provides a frequency of about 30 Hz.
